(19) United States
(12) Patent Application Publication
(10) Pub. No.: US 2022/0277405 A1
(43) Pub. Date: Sep. 1, 2022

(54) Adaptation of a Production Process, Edge Device of an Industrial Control System and Product Ordering Process

(71) Applicant: Siemens Aktiengesellschaft, Muenchen (DE)

(72) Inventors: Rafael ANICET ZANINI, Nürnberg (DE); Tassio Abreu DE SOUZA, Belo Horizonte (BR); Gautier JEHL, Nürnberg (DE)

(21) Appl. No.: 17/629,821

(22) PCT Filed: Jul. 26, 2019
(86) PCT No.: PCT/EP2019/070187

§ 371 Date: Jan. 25, 2022

(51) Int. Cl. G06Q 50/04; G06Q 10/06; G06Q 30/06; H04L 9/00

(52) U.S. Cl. CPC G06Q 50/04; G06Q 10/06315; G06Q 10/067; G06Q 30/0611; H04L 9/50

(57) ABSTRACT

A method for adapting a production process, an edge device of an industrial control system and a method for a product ordering process, wherein at least one first party node of a blockchain network is adapted to publish order transactions in the blockchain network, published order transactions are validated by the blockchain network, where at least one second party node of the blockchain network analyzes validated order transactions in the blockchain network by identifying validated order transactions, extracting order parameters, sending the order parameters to a simulation system, receiving a capacity parameter from the simulation system, generating an offer based on the capacity parameter, and adapting the production process based on the offer if the at least one first party node accepts the offer.

### CROSS-REFERENCE TO RELATED APPLICATION

This is a U.S. national stage of application No. PCT/EP2019/070187 filed 26 Jul. 2019.

### BACKGROUND OF THE INVENTION

### 1. Field of the Invention

The present invention relates to a method for adaption of a production process, an edge device of an industrial control system and a method for a product ordering process.

### 2. Description of the Related Art

In production industries, it is a challenge to produce the right amount of goods or products and to deliver them to the customer as ordered. On the one hand, producers must handle the uncertainty of the unknown level of demand for their products. A balance between high costs due to extensive stocking and the risk of delay in delivery times must be estimated based on former order intakes. From a perspective of a customer or orderer, placing an order is often times not transparent and inflexible in terms of price and delivery deadline.

In general, two different strategies for order management and production management are mainly known. On the one hand, push systems are based on the idea of producing goods before an order is created. This means that the production is going to engage or block resources without being sure what amount will be sold. As a result, storage costs and the risk of wasted products for example due to expiry dates have to be accepted. From a customer prospective, resulting delivery times are often short due to the availability of the product in stock.

On the other hand, pull systems are known. These systems rely on the mechanism to produce a good only as soon as a customer places an order. Especially nowadays with products having more and more variations and options, which can be chosen individually, more and more industries have to rely on this production mechanism. It provides more flexibility concerning the product and allows so called lot size zero applications. As a drawback, the customer has to wait for a longer time until his product is produced.

Both production systems rely on manual synchronization between different actors in the phase from production to sale, for example between production planning and sales.

### SUMMARY OF THE INVENTION

In view of the foregoing, it is an object of the present invention to provide methods and a device in the realm of industrial production that allows more balanced ordering and production management or an improved and more flexible ordering and production process.

These and other objects and advantages are achieved in accordance with the invention by a method for adaption of a production process, where at least one first party node of a blockchain network is adapted to publish order transactions in the blockchain network, where published order transactions are validated by the blockchain network, where the method comprises analyzing, by at least one second party node of the blockchain network, validated order transactions in the blockchain network, and where the analyzing comprises:
identifying validated order transactions,
extracting order parameters comprising at least an ordered amount of a product and an ordered delivery deadline for the product out of an identified order transaction,
sending the order parameters to a simulation system for simulation of a production process for the ordered product based on the order parameters,
receiving a capacity parameter from the simulation system,
generating an offer based on the capacity parameter, and if the at least one first party node accepts the offer, then adapting the production process based on the offer.

With the blockchain technology, a decentralized, distributed database is built, in which transactions, which are generated by the participating nodes, are securely stored, so that they are protected from manipulation. Therefore, transactions are deposited in a block and a block is chained with a subsequent block via a checksum mechanism. An explanation of the blockchain technology can be found on, for example, at the website Wikipedia.

Besides one or more transactions, in a block there is, for example, a hash value of the predecessor block contained. The block is sent from a node, who generated the block, to the blockchain network.

Depending on the consensus mechanism of a blockchain network, the integrity of the blockchain is guaranteed, e.g., through the majority of nodes being reliable nodes. In the network of nodes participating in the blockchain network, a new block is generated in regularly timely distance. As a basic mechanism, the hash value of a most recent validated block in the blockchain is included in a newly generated block. In the case that no new transaction has been broadcasted within the time interval, some blockchains skip the process of generating a block.

A blockchain saves transactions, which have been broadcasted to the network to be validated. If any block is validated within the respective consensus proceeding, then the valid blockchain increases with the validated block in terms of its length and size.

A checksum, in particular a hash value, of a predecessor block is integrated in a respective new block, so that a chain is created with backreferences to predecessor blocks. The checksum of the predecessor block together with the transaction of the most recent block constitutes the data set for the checksum of the successor block. A block therefore references at least one of the predecessor block. Transactions are therefore secured against manipulation, because a chain can be reviewed up to an initial block, the “genesis block”, due to the chaining of the blocks. As all transactions, in particular all validated transactions, are available within the blockchain network, it is possible to trace whether a content of a transaction is not in conformity with previous versions of the transaction. In other words, a manipulation of a transaction can be discovered by verifying the hash chain.

For industrial applications, public or private or federated blockchains are used. In a public blockchain, a consensus mechanism is public, which means that an unknown user group, e.g., in the publicly available internet, can validate a block and can build or create a validated blockchain, for example, through “mining”. In private blockchains or federated blockchains, the consensus mechanism is focused on “consortia”. The participants of a consortium, for example, are known to each other or to an administrative instance or fulfill a certain level of reliability.

A blockchain is part of a distributed database system. Distributed database means that the information of the database, in particular the chain in form of the blockchain, is available or can be saved in the location of any participant or on a plurality of memory locations of the different participants. It is a principal of the blockchain in a distributed database, that information of the blockchain lies decentrally. Participants of the distributed database can contribute to the generation of new blocks or can validate generated blocks. Moreover, a participant also can only read one or several specific blocks of a blockchain.

The key functionality of a blockchain based system, which is also used for the present invention, is the immutability of transactions as soon as they are validated by the blockchain. More specific, a claimed integrity of a transaction can be verified at any time after validation reviewing the chained blocks.

Published order transactions are transactions that comprise information about an order of a first party node. The first party node can, for example, be a customer or a reseller who places the order with a producer. The first party node can also be called an orderer or ordering node. As long as the published order transaction has only been broadcasted into the blockchain network, there is no certainty about the integrity of the transaction. Depending on the consensus mechanism, on which the blockchain network is based, a validation of published transactions can be initiated by specific nodes of the blockchain. For example, a dedicated group of validating nodes starts validating published order transactions, in particular as soon as a specific amount of transaction data has been accumulated or after a specific time has elapsed.

A validated order transaction is a transaction, for which there is a consent or agreement within the blockchain network, that it is trustworthy. Those validated order transactions can be identified, for example, by extracting them from the blockchain, in particular from the longest version of a blockchain within the network in case of several inconsistent continued blockchains, which can exist on parallel for a short while.

Moreover, a validated order transaction can be identified by using an identifier or ID of the transaction. If the order transaction corresponding to the ID has already been added to the blockchain, it is a validated order transaction.

The step of identifying validated order transactions is performed by at least one second party node.

A second party node is a node, which represents, for example, a producer within a blockchain network. In a possible embodiment, several nodes belong to a single producer. As a consequence, several second party nodes exist, who can check the blockchain for validated order transactions. In another embodiment, several producers participate in the blockchain network and respective second party nodes of the respective producers check the system for validated order transactions. In this scenario, several second party nodes, which do not belong to the same producer as entity within the network, analyze order transactions, which have been published by a first party node.

A second party node can also be a reseller, who exchanges information with a producer and a simulation system simulating a production and preferably also a corresponding stocking system.

In a next step, order parameters comprising at least an ordered amount of a product and an ordered delivery deadline for the product are extracted out of the identified order transaction. As key features of an order transaction, the following order parameters ordered amount and ordered delivery deadline have to be comprised in an order transaction. Those order parameters as well as additional parameters, which are part of the order transaction data set, are extracted by the second party node.

Based on these order parameters, a simulation system can be started for simulating a production process of the ordered product. For example, a simulation simulates the date at which the ordered product can be delivered to a customer. The simulation also can comprise a simulation of an actual available stock.

As a result of the simulation, a second party node receives a capacity parameter from the simulation system. The capacity parameter can, for example, comprise an indication, that the ordered amount can be delivered within an ordered delivery deadline by referring to the products in stock. In another embodiment, the capacity parameter can indicate that at least not the whole amount or number of ordered products can be delivered by referring to the products in stock, but that a production of the product is feasible under the boundary conditions set up by the orderer.

Also, in further embodiments, the capacity parameter can indicate, that the order parameters cannot be met. In these cases, the capacity parameter can comprise adapted order parameters, which can be met by the producer.

In a next step, the second party node generates an offer based on the capacity parameter. Corresponding to the capacity parameter, the offer can comprise the exact same order parameters as established by the first party node or adapted parameters.

If the at least one first party node accepts the offer, then the production process is adapted based on the offer. A production process in reality is adapted to ensure a products delivery with the conditions as agreed on between the first party node and the second party node.

In a possible embodiment, the step of identifying validated order transactions comprises searching published transactions of the blockchain based on key words representing an initiator of an order or an identification of a specific transaction or based on header information characteristic of an order or order format of a transaction. A second party node can, for example, search for a specific order or for an order of a specific first party node, especially for an order of a specific customer. The second party node can also or alternatively search the published transactions within the blockchain for specific header information. For example, the header indicates that a transaction is an order transaction. By only searching within transactions, which have been included into the chain, that means which have been validated, the second party nodes can make sure that only validated transactions are identified. By searching for key words that represent an initiator of an order, for example, an ID of the first party node or an ID of an orderer, a second party node can check the blockchain database in a favorable manner to query the blockchain for demand of first party nodes or for contract opportunities between the second party node and a first party node.

In a further embodiment, the step of extracting the order parameters comprises reading the order parameters, where the order parameters are included in a data set of the published transaction in unencrypted format or decrypting the order parameters with a symmetric key or a private key of an asymmetric key pair where the order parameters are included in a data set of the published transaction in encrypted format. Depending on the network participants, it is advisable, to publish transactions only in encrypted format. Where all the nodes trust each other, such as within a company blockchain network, the transactions can also be published without encryption. Here, order parameters can simply be read out of the blockchain.

In a further embodiment, sending the order parameters to a simulation system comprises creating a simulation smart contract, where the simulation smart contract implements automated rules for generating the capacity parameter. For example, all the information needed for the simulation by the simulation system, especially the order parameters as well as, for example, a tolerance range, can be sent to the simulation system. Tolerance ranges can be used to soften requirements as amount and deadline. They can indicate, e.g., a minimal deviation from the sent order parameters, where an order with an amount within a tolerance range is still of interest for the orderer.

A smart contract determines rules to generate an output with respect to input. The simulation smart contract defines rules, how to determine a capacity parameter, which is a simulated capacity parameter indicating the simulated capacity of a production process or a production system. With the constraints of the simulated production process like maximal throughput and the order parameters, an algorithm defined by the smart contract can generate the capacity parameter. The capacity parameter can be an indicator that the production of the ordered product can be fulfilled with the order parameters as comprised in the order query. In this case, the capacitor parameter can be a simple “ok” or “yes” as the indicator. If the simulation results in a scenario, in which the order parameters cannot be fulfilled, then the capacity parameter can be simple “no” as the indicator. In these cases, the capacity parameter can comprise further indication of possible readjustment of pending orders.

In a further possible embodiment, generating the offer comprises determining a price according to the capacity parameter. An offer is based on the capacity parameter. Preferably, the offer summarizes the conditions, under which the order can be fulfilled, in a way that the first party node can accept the offer without further clarification. For example, the ordered type of product, an amount of the product, a delivery time and a price are standard content of the offer.

The determination of the price reflects a simulation result, such that according to the capacity parameter, a price is adapted. For example, a standard price can be offered, if the capacity parameter indicates that the delivery date can be met drawing back to the products in stock or the production on demand. If, however, the simulation results in a capacity parameter, which shows that the order cannot be fulfilled by referring to the stocked products and the production, but also indicates, that considering shifting the production of other ordered products the order can be fulfilled with the order parameters, then a price is adapted, particularly increased.

In accordance with a further embodiment, the capacity parameter indicates a level of constraints of the production process, where product stock information and or further production processes of further products are considered. Thereby, capacity parameters can be simple indicators like traffic light indicators, where a green light means that the order can be fulfilled without further adaption or without impact on other products, which are produced within the production system. A yellow traffic light can indicate the production can be fulfilled, but there are rearrangements in the production process necessary, so that it is necessary to adapt the production process of other products, which are produced in the production system according to the simulation. A capacity parameter can also be red light, if even considering a stock information or an information about further production processes does not result in a simulation, in which the production could be fulfilled with the requested order parameters.

In another embodiment, the capacity parameter can consist of a more complex set of capacity parameters. It can, for example, be a set of data listing the simulation conditions, simulation input data, which mainly influenced the simulation result, the order parameters, as well as output data from the simulation, such as a simulated production time or a simulated delivery time or an extend of impact on further production processes. It can be of advantage to include especially a detailed capacity parameter in the offer so that it is part of the offer. This helps to make the process of generating the offer more transparent, especially if the capacity parameter as well as a price are included into the offer.

In accordance with a further embodiment, an order smart contract is created, where the order smart contract implements a logic for rules that are based on the accepted offer. For example, actions, that have to be triggered or performed according to the accepted offer, and as soon as certain requirements are fulfilled or conditions are met, can be set by the orders smart contract. In this way, a customer can see how an offer has been created by the second party node based on the corresponding order, can potentially get further information about a production step or a delivery time of the ordered product or have a record of the ordering and offering process as well as the contract information about the product delivery.

The order smart contract can, for example, initiate a payment as soon as the product has been delivered. In case of delays in the production process and a delayed delivery as a consequence, a first party node or a customer can initiate actions. Those actions may be additional content of the smart contract that the first party node and the second party node agreed on. For example, it is a favorable option to have a basic contract running between a first party node and a second party node as a basic smart contract, where general terms and conditions are part of the contract and on which both parties agreed. An order smart contract can preferably refer to the basic smart contract. This enables the set up of general terms and conditions within the blockchain network, especially regarding complaint management, breach of contract or similar scenarios.

In a further embodiment, a validation process in the blockchain is based on a consensus mechanism. The consensus mechanism can preferably be chosen according to a size of the blockchain network or interests within the network.

It is also an object of the invention to provide an edge device of an industrial control system, where the edge device comprises a cloud interface to a cloud system, where the cloud system has an established blockchain network and where the edge device is a second party node of the network, comprising a control interface to a control device of the control system, where the control device is connected to a simulation device, where the edge device is configured to identify validated order transactions in the blockchain network, where order transactions are published by first party nodes of the blockchain network and are validated by the blockchain network, and where the edge device is configured to extract order parameters comprising at least an ordered amount of a product and an ordered delivery deadline for the product out of an identified order transaction, and is configured to send the order parameters to the simulation device for simulation of a production process for the ordered product based on the order parameters, and is configured to receive a capacity parameter from the simulation device, generate an offer for a first party node of the identified order transaction based on the capacity parameter, and if the first party node accepts the offer, adapt the production process based on the offer.

In accordance with another embodiment, the edge device is configured to implement a method in accordance with disclosed embodiments of the method described in the context of the description of the method for adaption of a production process.

It is also an object of the invention to provide a method for a product ordering process, where the method comprises publishing, by a first party node of the blockchain network, at least one order transaction in a blockchain network, where the at least one order transaction comprises order parameters including at least an ordered amount of a product and an ordered delivery deadline for the product, where published order transactions are validated by the blockchain network, and comprises identifying, by the first party node, an offer transaction published by a second party node of the blockchain network corresponding to an offer of the second party node, where the offer transaction comprises offer parameters including the order parameters or adapted order parameters and including a price, where the offer parameters are based on a capacity parameter derived by the second party node, where the capacity parameter is derivable by a simulation of a production process for the ordered product based on the order parameters, and comprises accepting, by the first party node, the offer depending on the offer parameters, where the accepting comprises an ordering of the product.

From the perspective of the entity or node who orders a product, the disclosed embodiments of the invention enable a transparent ordering process, where the first party node, such as a customer, can get an offer that reflects information gained from a simulation of the production process. This opens the way to create offers with flexible price adaption considering potential constraints in the production process. By publishing order transactions with order parameters, which allow more flexibility for the producer, such as by publishing an order with a delivery deadline far in the future, the first party node can influence a price that is offered for the product. The other way around, a customer benefits from a flexible ordering and production system, where delivery deadlines are part of the order, in case that a product is needed urgently. In this case, a higher price can be acceptable.

In accordance with another embodiment, the accepting is performed automatically based on fulfillment of first rules defined in a first smart contract created by the first party node. Smart contracts can be used in a favorable manner to automatically implement logics, which have been agreed on between different parties or set up by one party in advance. This can accelerate processes as, for example, if the first party node waives the option of reconsidering a requested order after an offer has been created. If the offer matches the order parameters and, for example, also matches a tolerance range of an acceptable price, then a contract between the first party node and the second party node is created by accepting the offer automatically. This step of automating certain logics by rules of smart contracts can in a favorable manner also be managed and administrated via the blockchain network. In this way, certain transactions are triggered automatically in case all requirements of a smart contract are fulfilled and no manual action or manual publishing of transaction is necessary.

In accordance with another embodiment, the ordering of the product causes an adaption of the production process based on the offer parameters, where the production is performed based on fulfillment of second rules defined in a second smart contract created by the second party node. Also, on the second party node side, smart contracts can be used in a favorable manner to automate certain steps that can be triggered automatically after an agreement between the first party node and the second party node about products to be produced and delivered is reached.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the following different aspects of the present invention are described in more detail with reference to the enclosed figures, in which:

FIG. 1 shows a diagram of a possible exemplary embodiment of a blockchain network with participating nodes in accordance with an embodiment of the present invention;

FIG. 2 shows a schematic illustration of an edge device with its interactions with a blockchain network in accordance with an embodiment of the present invention;

FIG. 3 is a flowchart of the method for adaption of a production process in accordance with the invention;

FIG. 4 is flowchart of a method for a product ordering process in accordance with the invention.

### DETAILED DESCRIPTION OF THE EXEMPLARY EMBODIMENTS

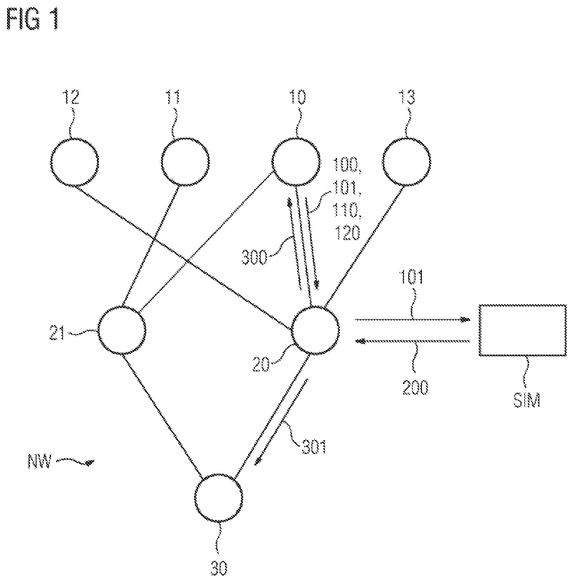

FIG. 1 illustrates in a schematic diagram several participating nodes of a blockchain network NW. Different roles of the nodes are indicated by three different layers of the network NW. For example, there are four blockchain nodes, which build first party nodes, 10, 11, 12, 13. For illustrative purposes only, the number has been restricted to four. The number of participating nodes is not restricted and will be higher in reasonable scenarios. The first party nodes are customer nodes and one of those nodes corresponds to a customer node 10 who wants to order a product.

The intermediate layer of participating nodes shows, by way of example, two nodes 20, 21 who act as resellers and who coordinate the ordering processes between the customer node 10 and a producer node 30 who will perform a production process. The producer node 30 builds the third layer of participating nodes and is illustrated as a production node of the blockchain network. Like in the case of the customer nodes, also the number of reseller nodes and producer nodes is limited only due to easier illustration. More than two reseller nodes and more than one producer node can exist in a blockchain network.

By way of example, the customer node 10 broadcasts an order transaction 100 with an order for a product, indicating a type of product, an amount to be ordered as well as an aspired delivery time. The order transaction 100 including order parameters 101 and more specifically two mandatory elements, namely an ordered amount 110 of a product and an ordered delivery deadline 120 for the product, is published and broadcasted by the customer node 10.

In a first step, the published transaction is part of a pool of unvalidated transactions in the blockchain. Depending on the consensus mechanism used in the blockchain network NW, different options for validating transactions can be provided. For example, in a federated blockchain network consisting of authenticated customers, resellers and producers, which build the nodes of the network, a consensus mechanism like proof of stake or similar concepts can be used.

As soon as a broadcast order transaction 100 has been validated, it is included into the blockchain database. The updated blockchain is broadcast to all participating nodes so that all nodes have a same database available. All reseller nodes 20, 21 have the opportunity to see the validated order transaction 100. In a possible embodiment, other customer nodes 10, 11, 12, 13 can query the blockchain for order transactions that are either their own order transactions or order transactions of other customers.

The reseller node 20 acts as a second party node, and with this role it searches the blockchain network NW for validated order transactions that have been broadcast to the blockchain network NW by any and at least one of the first party nodes 10, 11, 12, 13.

In a favorable embodiment, order transactions are encrypted by the customer node. For example, only resellers or only a specific reseller have/has a corresponding key to decrypt an encrypted order transaction. In this way, confidentiality of sensitive data of the order can be protected. At the same time, the details of the order transactions nevertheless form part of the blockchain database and are therefore secured such that a subsequent manipulation of the order data can be detected.

Customers prepare orders with two critical pieces of information: The quantity of an ordered product as well as the acceptable deadline for delivery. The order is dispatched to resellers by publishing the request on the blockchain.

A node can be performed on a smartphone, running on an App or on a personal computer or anywhere in a cloud, to which the blockchain is connected.

Depending on the order parameters 101, which characterize the order of the customer node 10, the customer node 10 can create or set up a smart contract describing the amount of product and the expected deadline. Therewith, the customer node 10 lays the foundation for a subsequent automatically triggered enforcement of actions, for example, triggering a payment to the reseller as soon as the product has been delivered to the customer.

The reseller gets the order by querying the blockchain and can simulate the feasibility according to the actual available stock and a capability by the production process by using a simulation system SIM. The simulation system SIM gets die order parameters as input data. All other data needed by the simulation system SIM, such as all the data concerning the production factory, including models of the plant, machines, tools, or materials, are fed into the simulation system in advance of a simulation. In the case that an amount of the product in stock is not sufficient, the capacity of a production can be simulated. The simulation of the production capabilities is running, for example, also on a smart contract. It first checks if the deadline can be reached without changing the current planning, whereas the current planning comprises the production of further products ordered earlier by the same or other customers. If the deadline cannot be reached without changing the current planning, then it will then try to reorder according to priorities and deadlines of individual customers. The following scenarios are possible:
a) A production can fulfill the order, i.e., due date and quantity are acceptable. The reseller can propose the price according to the quantity and deadline. Market logic could foresee that higher quantities can reduce the unit price or shorted due dates can nevertheless make it higher.
b) The production cannot fulfill the order. The reseller can either look in his stock or readjust pending orders for other customers or earlier orders with longer delays in order to fulfill the order. The price is adapted as a consequence and can be higher due to the necessary rearrangement. In this case, an optimization of the production process is done as a compromise between the actual stock, the virtual stock and the production. The virtual stock can be seen as the real actual stock corrected by a consideration of products to be produced due to orders that have already been accepted by the producer.
c) No compromise between the production and the pending orders from other customers is possible. In this case, an order must be refused. In other words, no offer can be made to the customer node.

On the technical side, resellers or pools of resellers are running their own nodes in the blockchain. They are connected to customer blockchain to be able to see their orders as well as to the producers blockchain to see the current production and line capacity.

When a simulation with the simulation system SIM by the reseller node 20 is finished, the simulation system SIM sends a capacity parameter 200 back to the reseller node. If the simulation results in an acceptable order, then the capacity parameter 200 is, for example, a dataset comprising an OK-message for the reseller. The reseller can also use the blockchain network NW to broadcast an offer transaction including an offer 300 back to the customer node 10. The offer transaction can be validated in the same way as the order transaction. The customer node 10 can accept the offer 300 with the proposed price or deny the offer 300. If the customer and reseller can agree on the contract conditions for the product delivery and close a contract by preferably again using transactions over the blockchain network, then the reseller can run a smart contract with the production node 30 comprising production data 301 that describe the adaption of the production planning. On the production side, the production data needs to be sent to the production line. The planning is adapted to ensure that the production is going to support all customer requests according to the respective quantities and deadlines.

The planning can be adapted so that optimization criteria are fulfilled. An optimization smart contract that runs on the blockchain can be based on, for example, the back pack loading algorithm. Given the parameters quantity, deadline and capacity of the production, this algorithm can distribute the orders over time in an optimized manner.

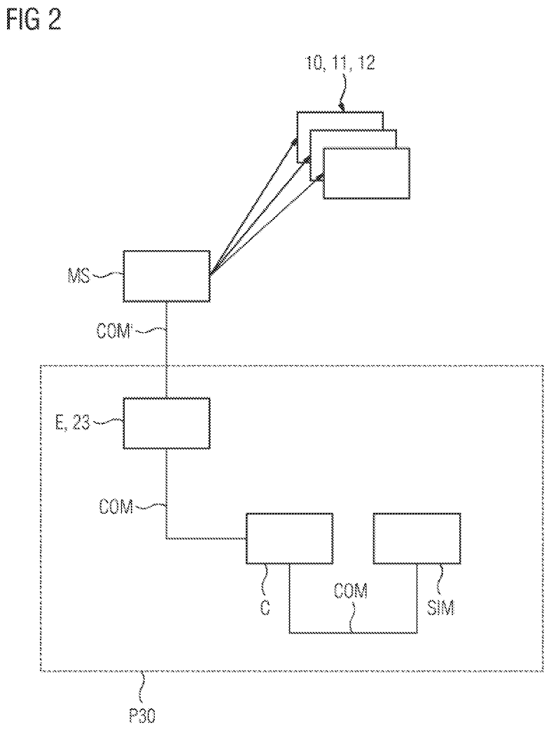

FIG. 2 schematically illustrates key components of a production plant P30. In accordance with the presently contemplated embodiment of the invention, a second party node is a producer node 23 who is a participating node of a blockchain network. The producer node 23 is running on an “edge device” E, which serves as a gateway between an industrial control unit C and a cloud platform MS. Customers also have access to the cloud platform MS. On this cloud platform MS, a blockchain is in place and customers can be seen as participating customer nodes 10 and as first party nodes.

A customer node 10, for example, accesses the blockchain via a personal computer in the customers office environment, and places orders via blockchain transactions, which are broadcasted to the blockchain community. The producer node 23 as second party node can identify orders of his customer, for example, by screening validated transactions in the blockchain database for an ID of the customer. The edge device E is part of an industrial automation system within a factory and is connected to the cloud platform MS via a Tunnel Setup Protocol/Internet Protocol (TSP/IP) connection COM′.

The edge device E transmits validated order transactions to a control device C via an Open Platform Communications United Architecture (OPC UA) connection COM. Moreover, there is a plant simulation system SIM running within the industrial automation system, which is connected to the industrial control unit C via OPC UA connection COM. The simulation system SIM is the basis for a decision of the producer P30 to classify the identified order as acceptable. The plant simulation system SIM considers an amount of already produced products in a stock as well as products to be produced within the deadline requested by the customer. The result of the simulation system is a capacity parameter.

Within the industrial control system, smart contracts can be set up that track, for example, production orders, product data as well as capacity parameters generated by the simulation system SIM. The execution of smart contracts automatically implements actions within the industrial control system as soon as requirements specified by the logic of the smart contract are fulfilled.

Based on the generated capacity parameter as output of the simulation, the logic of the smart contract can trigger that an offer transaction is broadcasted to the blockchain network. The offer can be accepted by the customer and as soon as there is an agreement between the customer and the producer, the production planning can be adapted.

Considering all available order information of a newly acquired customer and of potential further customers with further product orders, the productions planning is adapted. Preferably, an algorithm determines an optimized production planning that satisfies the individual orders as good as possible.

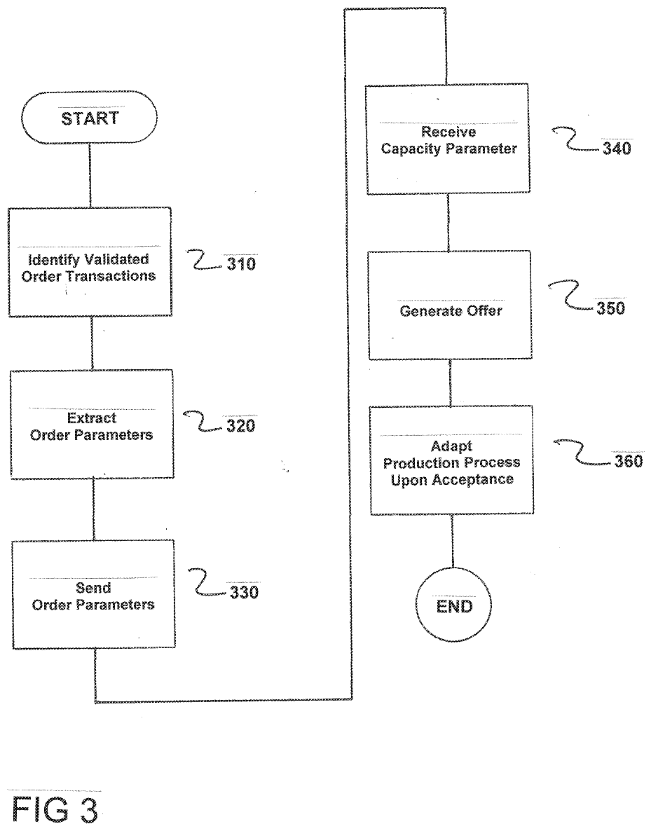

FIG. 3 is a flowchart of the method for adaption of a production process, where at least one first party node 10 of a blockchain network NW is adapted to publish order transactions 100 in the blockchain network, and published order transactions 100 are validated by the blockchain network NW.

The method comprises analyzing, by at least one second party 20 node of the blockchain network, validated order transactions 100 in the blockchain network, where the analyzing comprises identifying validated order transactions 100, as indicated in step 310.

Next, order parameters 101 comprising at least an ordered amount 110 of a product and an ordered delivery deadline 120 for the product out of an identified order transaction are extracted, as indicated in step 320.

Next, the order parameters 101 are sent to a simulation system SIM for simulation of a production process for the ordered product based on the order parameters 101, as indicated in step 330.

Next, a capacity parameter 200 is received from the simulation system SIM, as indicated in step 330. Next, an offer 300 based on the capacity parameter 200 is generated, as indicated in step 340.

Next, the production process is adapted based on the offer 300 if the at least one first party node 10 accepts the offer 300, as indicated in step 350.

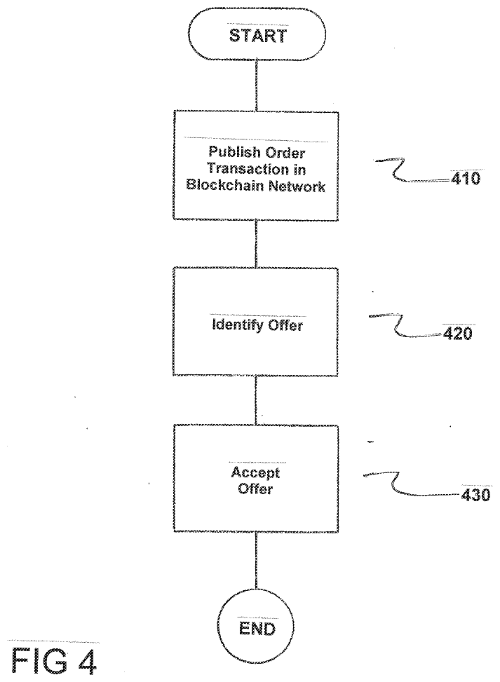

FIG. 4 is a flowchart of the method for a product ordering process. The method comprises publishing, by a first party node 10 of a blockchain network NW, at least one order transaction in a blockchain network NW, as indicated in step 410. Here, the at least one order transaction comprises order parameters including at least an ordered amount of a product and an ordered delivery deadline for the product, and published order transactions are validated by the blockchain network NW.

Next, the first party node 10 identifies an offer transaction published by a second party node 20 of the blockchain network NW corresponding to an offer of the second party node 20, as indicated in step 420. In accordance with the invention, the offer transaction comprises offer parameters including the order parameters or adapted order parameters and including a price, the offer parameters are based on a capacity parameter derived by the second party node, and the capacity parameter being derivable by a simulation of a production process for the ordered product based on the order parameters.

Next, the first party node 10 accepts the offer depending on the offer parameters, as indicated in step 430. Here, the acceptance comprises an ordering of the product.

It is an advantage of the disclosed embodiments of the invention that the production of a product becomes directly connected to market requirements. Data concerning a customer order or a production time line of ordered products can be made transparent and immutably tracked. The consideration of customer requirements, which can also be customized requirements as well as an improvement of a communication between customer and producer or reseller, can be achieved by implementing the disclosed embodiments of the invention.

Instead of managing only stocks and orders, a virtual stock corresponding to the orders made by several customers can be managed. This generally improves the stocking costs and maintains the market penetration with lower delivery delays. Finally, a producer is not required to take and complete orders in a sequence they come in from customers. The integration of customer priorities through the deadlines enables to bring more flexibility into the producer's business and respond to customers' expectations in a better way.

On the other hand, customers get choices that were not possible with conventional ordering processes. The general customer experience is to buy a product at a price and then wait for availability. With the method and system in accordance with the disclosed embodiments of the invention, the customer can decide when he needs the product and choose between a lower price or a faster service. Moreover, an order is not required to be something fixed from the very beginning from the producer point of view. As long as a production has not started, the disclosed embodiments of the invention allow dynamic canceling or shifting of orders and allow planning of a new production limited by the confirmed delivery deadlines only.

It is an advantage of the disclosed embodiments of the invention, that an operator of a production plant can use the blockchain based ordering process to better balance its stocks and the production according to the requests of the market. Moreover, by using smart contracts procedures communications with customers can be automated. A producer can, at the same time, act in the role of a customer of his suppliers and can also use the blockchain based order process for the relationship to his own suppliers.

By using smart contracts, it is possible to automate rules of the smart contract submitted to the blockchain, so that whenever an action is triggered, the contract can incorporate smart steps either to validate, optimize or take actions according to its inputs. This allows a complete integration between sellers and production planers, reducing the gap and need for manual interaction between systems.

It is moreover an advantage of the disclosed embodiments of the invention that no central database is needed, which is owned by a central authority, who all the participating parties trust. It is also an advantage, that by using the blockchain based ordering mechanism, the data concerning orders and offers as well as additional communication regarding delivery of a product etc. is stored in the blockchain database decentrally. In case of a failure, the distributed storage of the blockchain database enables the system to still run. Individual nodes affected by the failure can update their database based on the distributed information with little to no effect on the overall system.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-13. (canceled)

14. A method for adaption of a production process, at least one first party node of a blockchain network being adapted to publish order transactions in the blockchain network, and published order transactions being validated by the blockchain network, the method comprising:
analyzing, by at least one second party node of the blockchain network, validated order transactions in the blockchain network, said the analyzing comprising:
identifying validated order transactions;
extracting order parameters comprising at least an ordered amount of a product and an ordered delivery deadline for the product out of an identified order transaction;
sending the order parameters to a simulation system for simulation of a production process for the ordered product based on the order parameters;
receiving a capacity parameter from the simulation system;
generating an offer based on the capacity parameter, and
adapting the production process based on the offer if the at least one first party node accepts the offer.

15. The method of claim 14, wherein said identifying validated order transactions comprises searching published transactions of the blockchain based one of (i) on keywords representing an initiator of an order or an identification of a specific transaction and (ii) header information characteristic of an order format of a transaction.

16. The method of claim 14, wherein said extracting the order parameters comprises one of (i) reading the order parameters, said order parameters being included in a dataset of the published transaction in unencrypted format and (ii) decrypting the order parameters with a symmetric key or a private key of an asymmetric key pair, said order parameters being included in a dataset of the published transaction in encrypted format.

17. The method of claim 15, wherein said extracting the order parameters comprises one of (i) reading the order parameters, said order parameters being included in a dataset of the published transaction in unencrypted format and (ii) decrypting the order parameters with a symmetric key or a private key of an asymmetric key pair, said order parameters being included in a dataset of the published transaction in encrypted format.

18. The method of claim 14, wherein sending the order parameters comprises creating a simulation smart contract which implements automated rules for generating the capacity parameter.

19. The method of claim 15, wherein sending the order parameters comprises creating a simulation smart contract which implements automated rules for generating the capacity parameter.

20. The method of claim 16, wherein sending the order parameters comprises creating a simulation smart contract which implements automated rules for generating the capacity parameter.

21. The method of claim 14, wherein the capacity parameter indicates a level of constraints of the production process; and wherein at least one of product stock information and further production processes of further products are considered.

22. The method of claim 14, wherein generating the offer comprises determining a prize according to the capacity parameter.

23. The method of claim 14, wherein an order smart contract which implements a logic for rules that are based on the accepted offer is created.

24. The method of claim 14, wherein a validation process in the blockchain is based on a consensus mechanism.

25. An edge device of an industrial control system, comprising:
a cloud interface to a cloud system, the cloud system including an established blockchain network and the edge device forming a second party node of the network;
a control interface to a control device of the control system, the control device being connected to a simulation device;
wherein the edge device is configured to:
identify validated order transactions in the blockchain network, order transactions being published by first party nodes of the blockchain network and being validated by the blockchain network;
extract order parameters comprising at least an ordered amount of a product and an ordered delivery deadline for the product out of an identified order transaction;
send the order parameters to the simulation device for simulation of a production process for the ordered product based on the order parameters;
receive a capacity parameter from the simulation device;
generate an offer for a first party node of the identified order transaction based on the capacity parameter; and
adapt the production process based on the offer if the first party node accepts the offer.

26. The edge device of claim 25, wherein said identification of the validated order transactions comprises searching published transactions of the blockchain based one of (i) on keywords representing an initiator of an order or an identification of a specific transaction and (ii) header information characteristic of an order format of a transaction.

27. The edge device of claim 25, wherein said extraction of the order parameters comprises one of (i) reading the order parameters, said order parameters being included in a dataset of the published transaction in unencrypted format and (ii) decrypting the order parameters with a symmetric key or a private key of an asymmetric key pair, said order parameters being included in a dataset of the published transaction in encrypted format.

28. The edge device of claim 27, wherein said extraction of the order parameters comprises one of (i) reading the order parameters, said order parameters being included in a dataset of the published transaction in unencrypted format and (ii) decrypting the order parameters with a symmetric key or a private key of an asymmetric key pair, said order parameters being included in a dataset of the published transaction in encrypted format.

29. The edge device of claim 25, wherein sending the order parameters comprises creating a simulation smart contract which implements automated rules for generating the capacity parameter.

30. The edge device of claim 27, wherein sending the order parameters comprises creating a simulation smart contract which implements automated rules for generating the capacity parameter.

31. The edge device of claim 28, wherein sending the order parameters comprises creating a simulation smart contract which implements automated rules for generating the capacity parameter.

32. The edge device of claim 25, wherein the capacity parameter indicates a level of constraints of the production process; and wherein at least one of product stock information and further production processes of further products are considered.

33. The edge device of claim 25, wherein said generation of the offer comprises determining a prize according to the capacity parameter.

34. The edge device of claim 25, wherein said edge device is further configured to create an order smart contract which implements a logic for rules that are based on the accepted offer.

35. The edge device of claim 25, wherein a validation process in the blockchain is based on a consensus mechanism.

36. A method for a product ordering process, the method comprising:
publishing, by a first party node of a blockchain network, at least one order transaction in a blockchain network, the at least one order transaction comprising order parameters including at least an ordered amount of a product and an ordered delivery deadline for the product, and published order transactions being validated by the blockchain network;
identifying, by the first party node, an offer transaction published by a second party node of the blockchain network corresponding to an offer of the second party node, the offer transaction comprising offer parameters including the order parameters or adapted order parameters and including a price, the offer parameters being based on a capacity parameter derived by the second party node, and the capacity parameter being derivable by a simulation of a production process for the ordered product based on the order parameters; and
accepting, by the first party node, the offer depending on the offer parameters, said accepting comprising an ordering of the product.

37. The method of claim 36, wherein said accepting the offer is performed automatically based on fulfillment of first rules defined in a first smart contract created by the first party node.

38. The method of claim 36, wherein said ordering of the product causes an adaption of the production process based on the offer parameters; and wherein said adaption is performed based on fulfillment of second rules defined in a second smart contract created by the second party node.
